(19) United States
(12) Patent Application Publication
(10) Pub. No.: US 2015/0029743 A1
(43) Pub. Date: Jan. 29, 2015

(54) COMPONENT FOR THE EXTERIOR SURFACE OF A VEHICLE

(71) Applicant: Daimler AG, Stuttgart (DE)

(72) Inventors: Philipp Gneiting, Stuttgart (DE); Jens Humpenoeder, Ulm (DE); Holger Rothenburger, Ulm (DE); Philipp Stein, Ulm (DE); Margit Veeh, Ulm (DE)

(21) Appl. No.: 14/378,126

(22) PCT Filed: Dec. 22, 2012
(86) PCT No.: PCT/EP2012/005366

§ 371 Date: Aug. 12, 2014

(30) Foreign Application Priority Data
Feb. 21, 2012 (DE) 10 2012 003 452.0

(51) Int. Cl. B60Q 1/26; F21S 8/10

(52) U.S. Cl. CPC B60Q 1/2619; F21S 48/00; F21W 2101/00
USPC 362/559

(57) ABSTRACT

A component (1) for the outer surface of a vehicle (F), with a fibre composite (2) and at least one matrix plastic serving to stabilise the fibre composite (2). Optically or optically-electrically active elements (3) are integrated into the fibre composite (2). The optically active elements (3) have electroluminescent fibres (3) and/or the fibre composite (2) has an at least partial electroluminescent coating (7) as the optically active elements (3), which is in contact with electrically conductive fibres in the fibre composite (2).

The invention relates to a component for the outer surface of a vehicle according to the type defined in greater detail in the preamble of claim 1.

As well as sheet components as panelling for the outer surface of vehicles, components made from fibre-reinforced plastic material are, in the meantime, generally known and typical. Such components typically comprise a fibre composite and at least one matrix plastic serving to stabilise the fibre composite. Such a matrix plastic, which is typically formed as a plastic, holds the individual fibres together and typically seals the fibre composite from the outside from environmental influences. Here, various matrix plastics are known and typical, for example resins, thermoplastic materials or similar. For the purpose of sealing the outer surface from environmental influences and for creative colouring, the panelling can have a lacquer added to it. Here, both thermally cross-linking and UV-curable and cross-linking lacquers, lacquer films or similar are conceivable and possible.

As well as this, it is known from the general prior art for optically or optically-electrically active elements to be able to be introduced into textile materials, which, for example, can be used for trim or the internal lining of vehicles. Thus, it is, for example, known from a publication in the Ostthüinger Zeitung dated 21 May 2010 by the Institute for Specialised Textiles and Flexible Materials under the title “Nicht nur für den Autohimmel” (Not just for vehicle headliners), that luminous textiles can be constructed by integrating miniaturized SMD LEDs. Electroluminescent textiles are also known from the publication, which, for example, can be printed with electroluminescent pastes in the desired manner using the screen printing method. The electroluminescent material can then undergo excitation for illumination by electrically conductive threads introduced into the textile material.

Furthermore, the integration of optical waveguides or optical fibres in such materials is known from the work of the Textile Research Institute Thuringia (TITV, Greiz).

A cladding element having an opening that is left by means of an electroluminescent illuminant is described by the German utility model 20313916 U1. Moreover, DE 10 2010 013 784 A1 describes a membrane that has luminescent substances added to it, such that this has an afterglow after light irradiation and can be recognised more easily in traffic.

Light-conducting fibres in woven or knitted textiles are known from further documents in the prior art, for example from DE 101 10 329 A1 or, in line with a fibre-reinforced plastic component, are also known from DE 10 2005 061 507 A1.

The object of the present invention is now to specify a component for the outer surface of a vehicle, which offers a high level of flexibility in terms of its configuration, with minimal additional cost during the production.

According to the invention, this object is solved by a component having the features in the characterising part of claim 1. Further advantageous embodiments of the component according to the invention arise from the remaining claims that are dependent hereon.

The component according to the invention is fundamentally constructed as a component made from a fibre composite material. It has a fibre composite as well as at least one matrix material, which stabilises the fibre composite. According to the invention, optically or optically-electrically active elements are integrated into the fibre composite. Due to this functional integration of optically or optically-electrically active elements into the fibre composite of the component that is present anyway, a very light component can be achieved. During the production of the fibre composite, for example by weaving, knitting or stitching, a functional integration of optically active or optically-electrically active elements into the fibre composite can take place without a large amount of additional expenditure. Electroluminescent effects in the exterior skin of the vehicle can hereby be produced simply, with a high level of flexibility and very efficiently. This enables the emphasis of significant design features, for example by illuminating the roof by accentuating lines or edges. In addition or as an alternative to this, a signal for warnings on the vehicle can take place, for example flashing images or warning symbols.

Moreover, information such as the marking of corresponding points of the vehicle is possible. It would, for example, be conceivable, if a driver were making his/her way in the dark towards the vehicle, to mark the region of the door handle with electroluminescence, such that he/she could find it quickly and easily. A further, highly advantageous application would be the use of the component as an advertising space. It is hereby possible to attach alternating advertisements to the outer surface of a vehicle and to adapt these in terms of their content and/or optics, according to need, the environment in which the vehicle is moving, lighting conditions and suchlike.

Due to the direct functional integration of the components, the additional expenditure compared to conventional fibre-reinforced composite materials as components for the exterior skin of a vehicle is kept within narrow bounds. This additional effect can thus be produced simply, efficiently and highly cost-effectively.

Here, provision can additionally or alternatively be made for the fibre composite to have an at least partial electroluminescent coating as the optically active element, which is in contact with electrically conductive fibres in the fibre composite. For example, the fibre composite can be coated with electroluminescent materials via screen printing methods in the desired configuration and in the desired design, said materials in particular being able to be applied to the fibre composite as a paste. A charging of the electroluminescent coating by means of the electrical power required for excitation can take place highly simply and efficiently via electrically conductive fibres in the fibre composite, in particular by yarns that are metal-coated by galvanising methods. Due to the fact that the electroluminescent coating can, for example, be applied by screen printing methods in approximately each design, this is particularly well suited for labelling, advertising or suchlike. A complete, weak illumination of the entire vehicle can also be carried out in this way, if its outer surface is constructed overall from components according to the invention. This is a considerable safety advantage, for example under diffuse lighting.

In order to render the optical effect particularly clearly visible, provision can, according to an advantageous embodiment of the component according to the invention, be made for the matrix plastic to be designed to be at least partially transparent. An at least partially transparent matrix plastic can, in particular in conjunction with correspondingly arranged, optically active or optically-electrically active elements in the component, lead to specific design effects, for example by different lighting effects being brought about by a spatial variation in the transparency of the matrix plastic.

In a particularly expedient and advantageous development of the component according to the invention, a sealing of the component, for example with a lacquer or lacquer film, is here also designed to be at least partially transparent. This can, in the case of a completely illuminating component, be implemented in such a way that, with a suitable configuration of the sealing, only individual regions light up at full intensity, while other regions are shielded or partially shielded by the sealing that is not transparent in this region, such that different light intensities arise at different points of the surface of the component.

The component according to the invention is thus preferably configured as a panelling, in particularly a panelling that can be easily exchanged. However, it is also conceivable to provide structural components according to the invention, which remain at least partially visible, i.e. which are not at least partially covered up.

Further embodiments of the component according to the invention arise from the remaining dependent claims and are clear from the exemplary embodiment, which is depicted in greater detail below with reference to the figures.

Here are shown:

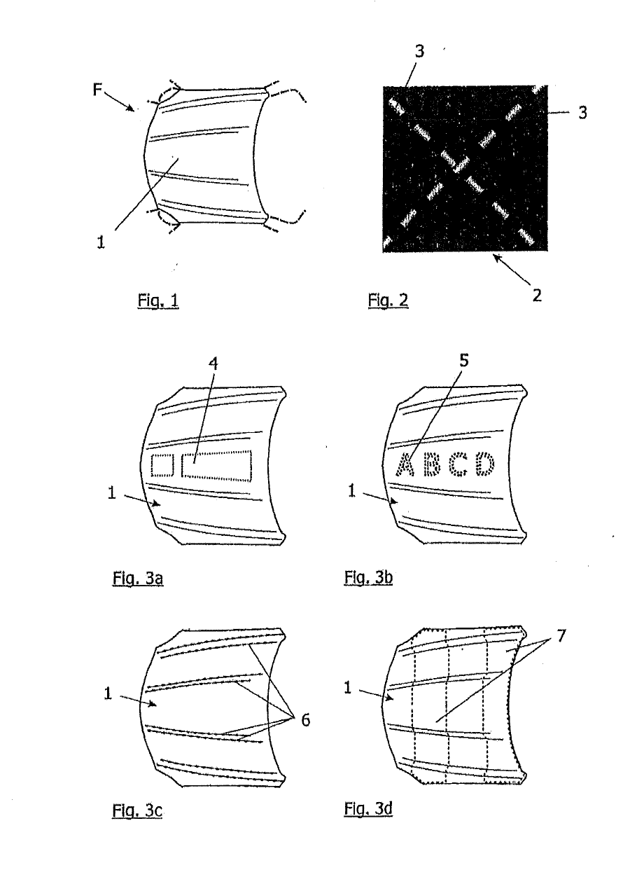

FIG. 1 a car bonnet as an example for a component according to the invention

FIG. 2 a detail from a fibre composite integrated into the car bonnet; and

FIG. 3 several examples of a potential use of the panelling according to the invention.

The top view of a car bonnet 1 as an example for a component 1 according to the invention is shown in the depiction of FIG. 1. As well as this panelling as a component 1 for the exterior skin of a vehicle F that is not depicted in its entirety, other components may of course also be embodied as the component according to the invention, such as doors, mud guards, roofs, spoilers or other panelling, attachment or structural components attached in the outer region of the vehicle F, either partially or as a whole.

The exemplary car bonnet 1 has a fibre composite 2, for example in the form of a carbon fibre fabric, which is stabilised into a fibre-reinforced composite component by a matrix plastic. The car bonnet 1 can consist partially or entirely of such a fibre-reinforced plastic with the fibre composite 2 as a load-bearing component.

As well as the use of carbon fibres, other fibre types such as aramid, Kevlar, polyamide fibres or similar fibres may of course also be used for the production of the fibre composite.

In the enlarged depiction of FIG. 2, such a fibre composite 2 can be detected in an enlarged depiction. The fibre composite 2 depicted here by way of example is a fibre composite that is embodied in the form of a fabric made from individual fibre bundles, so-called rovings. Now, optically or optically-electrically active elements 3 can be integrated into this fibre composite 2. In the exemplary embodiment depicted here, this takes place in the form of two electroluminescent fibres or fibre bundles with the reference numeral 3 added to it/them. These can be clearly detected in the fibre composite 2 depicted in FIG. 2. They can, for example, undergo excitation by creating an electrical power for illumination. Here, a varied configuration is possible, since typical configuration techniques from the textiles industry may be used in order to add the electroluminescent fibres 3 to suitable regions of the fibre composite 2. Thus, various design options enable the attachment of warning signs, advertisements or suchlike to the car bonnet 1 or to the panelling 1 to be carried out. Here, the electroluminescent fibres 3 only have to be supplied with electrical power in order to excite them for lighting. Targeted illumination of specific regions of the fibre composite 2 is achieved with minimal electrical energy input. By appropriate coverage with partially transparent and partially non-transparent seals, or with a partially transparent and partially non-transparent matrix plastic, further details can be integrated into the design of the optically active covering element 1.

Four different potential variants are shown purely by way of example in the depiction of FIG. 3. Thus, for example, in the case of the car bonnet 1 shown in FIG. 3a, a graphical element 4 in the form of an exclamation mark is applied with illumination to the car bonnet 1. This can, for example, be activated as a warning sign when needed. In the depiction of FIG. 3b, lettering 5 is depicted by way of further example; individual edges in the depiction of FIG. 3c are emphasised with illumination on the car bonnet 1 by lines 6 as design elements.

A further variant is depicted in the depiction of FIG. 3d. Instead of individual electroluminescent fibres 3, as in the hitherto existing exemplary embodiments, electrically conductive fibres—which are not depicted here—are integrated into the fibre composite 2, for example using a yarn with a metallic coating added to it, or suchlike. This is in contact with a coating 7 made from electroluminescent material that is attached to the fibre composite 2. This coating 7 is, in the depiction of FIG. 3d, depicted in the form of two crossbeams that run over the car bonnet 1. During the charging of the electrically conductive fibres with voltage, it is not the individual fibres, but rather the two crossbeams that are denoted with the number 7, which then undergo excitation for illumination. An extensive optical effect hereby occurs.

Here, the depictions are to be understood as purely exemplary; no creative limits are set in terms of the freedom with respect to shape, colour and intensity of the optically active or optically-electrically active elements.

1. A component (1) for the outer surface of a vehicle (F), comprising a fibre composite (2) and at least one matrix material stabilising the fibre composite (2), wherein optically or optically electrically active elements (3) are integrated into the fibre composite (2); and wherein the optically active elements (3) comprise electroluminescent fibres (3) and/or the fibre composite (2) has an at least partial electroluminescent coating (7) as optically active elements (3), which are in contact with electrically conductive fibres in the fibre composite (2).

2. The component (1) according to claim 1, wherein the fibre composite (2) is embroidered with the optically active elements (3).

3. The component (1) according to claim 1, wherein the fibre composite (2) is a fabric, braid, mesh, stitch-bond or knit made from fibres.

4. The component (1) according to claim 1, wherein the matrix plastic is at least partially transparent.

5. The component (1) according to claim 1, comprising an at least partially transparent sealing.

6. The component according to claim 1, wherein the component is a panelling or a structural component.
